(19) United States
(12) Patent Application Publication
(10) Pub. No.: US 2010/0152869 A1
(43) Pub. Date: Jun. 17, 2010

(54) PHASED ACCEPTANCE OF A PRODUCT

(75) Inventors: Patrick Shane Morrison, Marietta, GA (US); Kurt Donald Huber, Coral Springs, FL (US); William Gordon Mansfield, Sugar Hill, GA (US)

Correspondence Address: AT&T Legal Department - T&W;Attn: Patent Docketing, Room 2A-207, One AT&T Way, Bedminster, NJ, 07921, US

(73) Assignee: AT&T Mobility II LLC, Atlanta, GA (US)

(21) Appl. No.: 12/333,633

(22) Filed: Dec. 12, 2008

(51) Int. Cl. G06F 19/00; G06Q 10/00; G06Q 30/00

(52) U.S. Cl. 700/96; 705/7; 705/80; 700/109

(57) ABSTRACT

System(s) and method(s) are provided to enable phased acceptance of a product as part of an acquisition contract. Phased acceptance establishes a set of one or more phases of product acceptance, each directed to grant approval of a set of specific aspects of the product based at least in part on one of quality of operation or functional performance. Operational and functional performance metrics that determine acceptance thresholds in each acceptance phase are negotiated between a vendor and a client. To protect investment, phased acceptance can include remedies as part of each phase of acceptance based at least on one of product operational or functional failures, or unavailable features vendor committed to during negotiation of performance metrics; the remedies include at least one corrective measures or liquidated damages. A Final acceptance phase is the last approval from client to vendor, and can be employed to close out the acquisition contract.

### TECHNICAL FIELD

The subject innovation relates to product acquisition and deployment and, more particularly, to assessing through various phases a quality, performance, reliability and stability, and functionality of a product in order to accept a product acquisition.

### BACKGROUND

Acquisition or purchase agreements of multi-element product(s) for complex, large scale operation, such as wireless networks and service networks associated therewith, includes an acceptance process that gauges manufacturing quality of product elements, installation and integration, commissioning, functionality, monitoring of operation reliability and stability, and work quality of a deployments; the acceptance aims to properly “accept” or conclude the acquisition. Since product(s) acquisition and deployment typically is directed to a specific market and effected within a specific market, e.g., a wireless network deployment primarily serves a marketplace associated with the deployment area, multi-element product(s) have been generally accepted through utilization of methodologies and testing on a per market basis. Such acceptance approach generally exploit aspects and resources largely native to the market in which the acquisition or purchase is conducted. However, as business initiatives become less regional in scope, a per-market product(s) acceptance approach mitigates non-regional expansion and standardization of the acceptance process.

### SUMMARY

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject innovation provides system(s) and method(s) to enable phased acceptance of a product as part of an acquisition contract. Phased acceptance establishes a set of one or more phases of product acceptance, each directed to grant approval of a set of specific aspects of the product based at least in part on one of quality of operation or functional performance. Operational and functional performance metrics that determine acceptance thresholds in each acceptance phase are negotiated between a vendor and a client. To protect investment, phased acceptance can include remedies as part of each phase of acceptance based at least on one of product operational or functional failures, or unavailable features vendor committed to during negotiation of performance metrics; the remedies include at least one corrective measures or liquidated damages. Corrective measures are specific to a phase of acceptance, while whereas liquidated damages can be negotiated and are determined based at least in part on fault severity associated with failures that led to implementation of corrective measures. A Final acceptance phase is the last approval from client to vendor, and can be employed to close out the acquisition contract.

While various examples of product(s) are related to a wireless network and components or networks associated thereto, the phased acceptance process described in the subjection innovation can be utilized to accept almost any, or any, product(s). For instance, service networks such as internet service provider network, enterprise network(s), or the like; industrial assembly lines; equipment for thin-film solid state device deposition and preparation such as molecular beam epitaxy, chemical vapor deposition; particle accelerator and collider.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF DRAWINGS

FIG. 1 is a block diagram of an example system that facilitates or enables phased acceptance of a product as part of a purchase agreement in accordance with aspects described herein.

FIG. 2 illustrates a diagram of example phased acceptance of a product in accordance with aspects described herein.

FIG. 3 illustrates a block diagram of an example embodiment of a component that facilitates implementation of one or more tests related to operation and functionality of a product, and monitoring thereof, within an acceptance phase in accordance with aspects of the subject specification.

FIG. 4 presents illustrative example categories of operational quality indicators in accordance with aspects disclosed herein.

FIG. 5 presents a flowchart of an example method for phased acceptance of one or more products in accordance with aspects described herein.

FIG. 6 presents a flowchart of an example method for phased acceptance of product(s) in accordance with aspects described herein.

FIG. 7 is a flowchart of a method for evaluating product(s) elements as a part of an element phase acceptance according to aspects of the subject innovation.

FIG. 8 is a flowchart of an example method for monitoring performance during a reliability and stability period according to aspect of the subject innovation.

FIG. 9 is a flowchart of an example method for evaluating performance of product(s) according to aspects of the subject innovation.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” “service,” “framework,” and the like are intended to refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment,” “mobile station,” “mobile,” subscriber station,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification. Likewise, the terms “access point,” “base station,” “Node B,” “evolved Node B.” “home Node B (HNB),” and the like, are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms) which can provide simulated vision, sound recognition and so forth.

In the subject innovation, a product refers to a multi-component entity that typically requires one or more stages of integration, commission and deployment, or field tests prior to being fully functional. It is noted that various examples of product(s) are related to a wireless network (e.g., GSM, UMTS, Femto) and components or networks (e.g., Enhanced 911) associated thereto, the phased acceptance process described in the subjection innovation can be utilized to accept almost any, or any, product(s). Various examples of product(s) that can be accepted in accordance with aspects described herein are the following. Wireless networks and associated service networks such as internet service provider network, enterprise network(s), or the like; industrial assembly lines; equipment for thin-film solid state device deposition and preparation such as molecular beam epitaxy, chemical vapor deposition; particle accelerator and collider; and so forth. In addition, the various components that comprise the product can operate in either in disparate locations or in substantially the same location. As an example, a billing server associated with a wireless network can operate in a headquarters building, while a field site can host a transmission antenna that is part of the network. As another example, a particle accelerator and collider can control collision(s) in a main operating room while experiments that operate the collision itself can be deployed in a remote location.

Additionally, as discussed in greater detail below, the subject innovation provides system(s) and method(s) to enable phased acceptance of a product as part of an acquisition contract. Phased acceptance establishes a set of one or more phases of product acceptance, each directed to grant approval of a set of specific aspects of the product based at least in part on one of quality of operation or functional performance. Aspects, features and advantages of phased acceptance of a product as described herein can be applied to acceptance of most any or any wireless telecommunication network such as Wi-Fi, Femto cell, Worldwide Interoperability for Microwave Access (WiMAX), Enhanced General Packet Radio Service (Enhanced GPRS), Third Generation Partnership Project (3GPP) Long Term Evolution (LTE), Third Generation Partnership Project 2 (3GPP2) Ultra Mobile Broadband (UMB), High Speed Packet Access (HSPA), High Speed Downlink Packet Access (HSDPA), High Speed Uplink Packet Access (HSUPA), or LTE Advanced.

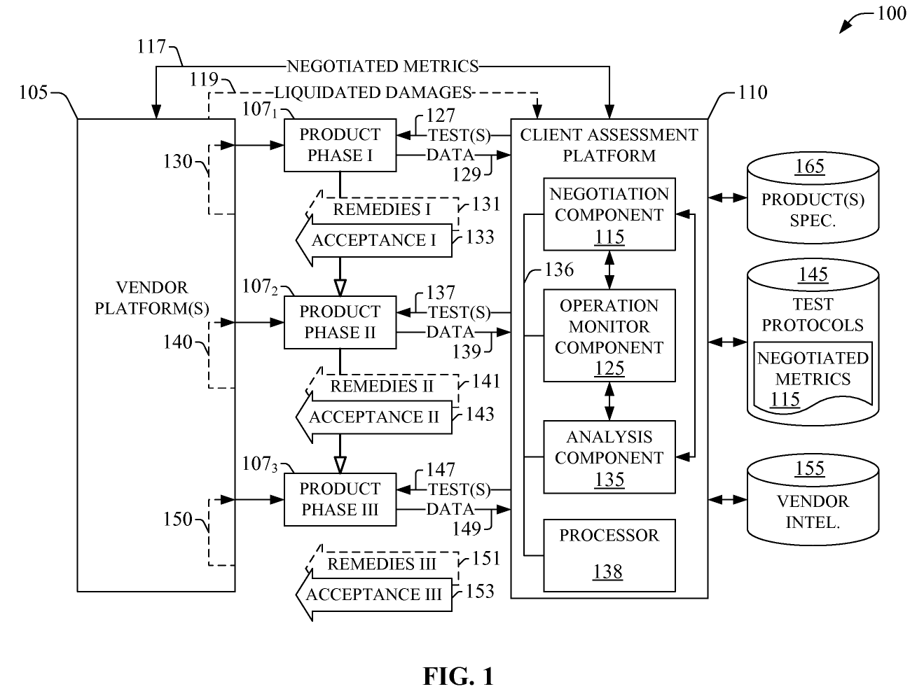

Referring to the drawings, FIG. 1 is a block diagram of a system that facilitates or enables phased acceptance of a product as part of a purchase agreement, the product originates from vendor platform(s) 105, which can include one or more vendors. Phased acceptance is a bottom-up approach that establishes a set of one or more phases of acceptance—e.g., in example system 100, three phases are illustrated—which are directed to grant approval of specific aspects of a product(s) based at least in part on quality of operation. Aspects assessed in each phase of acceptance increase in complexity with the phase of acceptance level; for instance, acceptance phase I can probe elements that comprise a product, while acceptance phase II can probe integrated elements that are an operational part of a product, and so forth. In an aspect of the subject innovation, the last phase of acceptance is deemed Final Acceptance can be employed to close out a product acquisition contract (e.g., a wireless network deployment contract), and proceed with other stipulated agreements (e.g., regular operation and maintenance service) if applicable.

It is noted that the bottom-up characteristics of phased acceptance facilitates to thoroughly protect an investment made by a client platform (e.g., a wireless service provider or carrier) to acquire the product (e.g., a wireless network and associated elements), since product acceptance in each phase is based upon performance test(s) of a product at each phases. To further ensure investment protection, remedies are contemplated as part of each phase of acceptance based at least on operational failures or unavailable features vendor platform(s) committed to during negotiation of performance; the remedies (e.g., remedies I 131) include at least one corrective measures or liquidated damages. Corrective measures are actively determined based upon gathered data (e.g., data 129) within each phase of acceptance, whereas liquidated damages (e.g., 119) can be negotiated and determined based at least in part on categories of fault severity associated with failures that led to implementation of corrective measures. In an aspect, corrective measures can include product element replacement (e.g., material in the product element is switched to a higher quality product like a switch from an average fiber optic link to a low-defect concentration fiber optic link; processor capacity in a gateway node is increased by introducing multi-core processors), firmware or software redesign of application(s) like billings applications, database access interfaces, packet data protocol context activation, etc.; deployment site(s) management changes; or the like. In an aspect, negotiation component 115 also can facilitate negotiation of liquidated damages. As an example, magnitude of a deployment delay (e.g., fault severity) related to tuning a set of directional antennas in a base station can dictate a magnitude of liquidated damages in view of the breach of performance in connection with the directional antennas. It should be appreciated that addition of liquidated damages and set points, e.g., magnitude, thereof in an acceptance phase can act as a financial driver for a vendor platform(s) to provide solution(s) (e.g., adjustment 130) to features of a product that breach negotiated performance.

In example system 100, a client assessment platform 110 negotiates with vendor platform(s) 105 acquisition of a product. Negotiation is facilitated through negotiation component 115, and can be supported by analysis component 135. As part of acquisition, negotiation component 115 can make public a bid process for a purchase contract of a product with predetermined specifications, e.g., retained in product(s) spec. 165, as determined by client platform assessment 110. Alternatively, or in addition, negotiation component 115 can exploit vendor intelligence 155, which can be accessed via a third party (e.g., through a database subscription). Vendor intelligence can provide a history of reliability, current technical capabilities, price point(s) for product elements, service and maintenance, or the like. Analysis component 135 can utilize such information to perform a risk analysis (e.g., an actuarial analysis) of specific vendor(s). Once vendor platform(s) is identified, negotiation component 115 can facilitate determination of a set of agreed performance metrics, or operation quality indicators (OQIs). An OQI is a function that evaluates operation or service quality based at least in part on a specific phase of acceptance. The function that defines an OQI can output numeric or logic values, the function is based at least in part on an intended performance or functional information to be collected. It should be appreciated that the OQI function dictates at least in part a set of measurements necessary to evaluate the OQI; the measurements can embody a group of test protocols, which can be retained in a memory element 145. In an aspect, OQIs comprise a set of negotiated metrics 117, or performance thresholds, that are conveyed to vendor platform(s) 105 and retained within test protocols 145 memory element.

Once negotiated metrics are established, a first acceptance phase is implemented. Client assessment platform 110, through operation monitor component 125, conducts test(s) 127 as a part of acceptance phase I and gathers data 129; data 129 is documented. Test(s) 127 can be implemented during monitoring periods that span a time interval Δτ (a day, a week, a month). Test(s) 127 are at least a part of test protocol(s) 145, which define specific measurements to be taken in order to assess a set of OQIs employed to evaluate performance of product phase I 107₁. When performance as measured by negotiated metrics 117 is below negotiated terms, remedies I 131 are effected. As part of remedies I 131 vendor platform(s) 105 can address deficiencies and implement a solution(s) cycle 130 that intends to renders performance of product phase I 107₁ satisfactory, or acceptable. Operation monitor component 125 resumes test(s) 127 and gathers additional data 129. Once performance of product phase I 107₁ meets negotiated metrics 117, acceptance I 133 is issued or granted by client assessment platform at least in part through analysis component 135, and acceptance phase is advanced to a next phase.

In acceptance phase II, operation monitor component 125 conducts test(s) 137, which is intrinsic to acceptance phase II and aims to probe disparate aspects of performance of product phase II 1072; data 139 is gathered and documented. It should be appreciated that acceptance phase II test(s) 137 are substantially directed to assessing integration of sets of operational elements that comprise product phase II 107₂. As in phase acceptance I, test(s) 137 are at least a part of test protocol(s) 145, which defines specific measurements to be taken in order to assess a set of OQIs employed to evaluate performance of product phase II 107₂. When performance as measured by negotiated metrics 117 is below negotiated terms, remedies I 141 are conveyed to vendor platform(s). Remedies II 141 can include assessment of negotiated liquidated damages 119. As part of remedies II 141, vendor platform(s) 105 can implement a solution(s) cycle 140 that intends to render performance of product phase II 107₂ satisfactory, or acceptable. Operation monitor component 125 resumes test(s) 137 and collects additional data 139. After performance of product phase II 107₂ meets negotiated metrics 117, acceptance II 143 is granted, and acceptance phase is advanced to a next phase, which is acceptance phase III.

Acceptance phase III has a set of test(s) 147 associated therewith, which are a part of test protocol(s) 145. In example system 100, acceptance phase III is the highest ranking acceptance phase and as such it focuses in the most complex aspects of product phase III 107₃. It should be appreciated that, in an aspect of the subject innovation, a final acceptance process is associated with test(s) 147 that evaluate functionality of isolated element(s), group of elements, and conglomerate of elements that provide product phase III its full functionality. When such full functionality fails to meet agreed negotiated metrics 117, e.g., a service provided by product phase III 107₃ fails to operate according to target or standard product protocol(s) such as user equipment handover, remedies 151 are conveyed to vendor platform(s) 105. Liquidated damages are determined and assessed bases at least in part on severity of an operation fault, e.g., which OQI(s) are faulted. As discussed above, a solution(s) cycle 150 can be implemented, and product phase III 107₃ can be submitted to further test(s) 147. Final acceptance III 153 is granted once phase III test(s) 147 indicate negotiated metrics are met.

At least two advantages of phased acceptance of phased acceptance of product(s) are following. (i) Phased acceptance approach can be substantially as fine grained as desired since one or more phases of acceptance can be implemented. (ii) Phased acceptance approach is product-centric and market and vendor agnostic since acceptance is standardized, through negotiated performance metrics and associated test protocol(s) or procedures; accordingly, phased acceptance for same product(s) can be effected across all markets via utilization of negotiated, or agreed upon, test procedure(s) and negotiated metrics.

In example system 100, processor 138 can be configured to confer, and confer, at least in part, functionality to component(s) within client assessment platform 110. To that end, processor 138 is functionally coupled to the component(s) through a data or system bus 136, and can execute code instructions stored in a memory, and exploit related data structures (e.g., objects, classes).

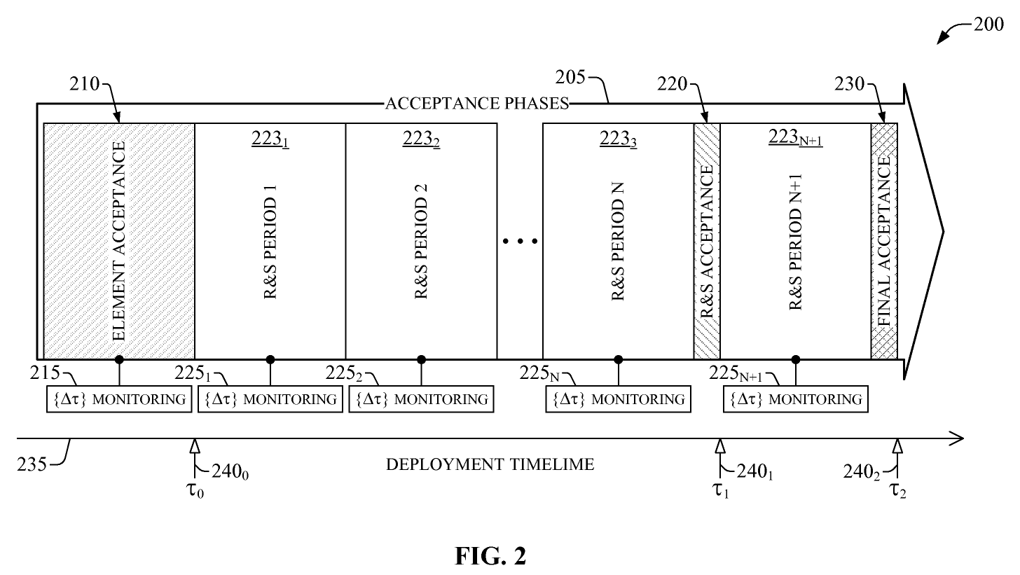

FIG. 2 illustrates a diagram of example phased acceptance 200 of a product, embodied in a wireless network, within a deployment timeline 235 in accordance with aspects described herein. Product elements include, but are not limited to, servers, computer-readable storage units or elements, radio towers and radio circuitry like transceivers, multiplexers/demultiplexers, modems; local links and backhaul links, which can comprise wired links (e.g., optical fiber backbone, twisted-pair line, T1/E1 phone line, a digital subscriber line (DSL) either synchronous or asynchronous, an asymmetric ADSL, or a coaxial cable . . . ) and wireless circuitry to operate wireless links; or the like. In addition, phased acceptance can include product elements like deployment infrastructure such as control rooms, server rooms, mass storage rooms; heat and air conditioning units; and so forth. It should be appreciated that at least a portion of these product elements can vary based at least upon considered wireless technology.

Acceptance phases 205 include three phases: (i) Element acceptance 210, Reliability and Stability (R&S) acceptance 220, and (iii) Final acceptance 230. Deployment timeline 235 illustrates the bottom-up aspect of phased acceptance. In an aspect of the subject innovation, R&S acceptance is preceded by a set of N R&S periods 223₁-223_{N}. Element acceptance 210 is directed to proper deployment of the product, e.g., wireless network. To that end, and to ensure that all individual product elements received from selected vendor platform(s) operate correctly and according to specifications, three disparate stages of product performance assessment. It should be appreciated that these stages embody test(s) 127. (a) First stage corresponds to pre-delivery acceptance, which includes factory inspection and test(s) of a representative sampling of product elements, e.g., network elements. Sampling of product elements can be negotiated as part of vendor platform(s) engagement, or commitment, and agreed product performance terms. As discussed above, as part of a phase of acceptance, failure of a test leads to remedies (e.g., remedies 131) implementation, which in an aspect of pre-delivery acceptance leads to review of failure among vendor platform(s) to determine an appropriate corrective action. Corrective action can include a commonly agreed solution(s) cycle (e.g., solution cycle 130) or plan to implement necessary, or required, changes. In addition, or as a result of failure to effect a solution(s) cycle, liquidated damages can be assessed as a penalty. (b) When agreed inspection and tests meet agreed product elements performance, second stage embodies installation acceptance, which includes tests of individual network element performance; the tests are conducted through installation, commissioning, and integration and outcome is contrasted with negotiated terms of performance. (c) Third stage comprises monitoring a pre-launch deployed product, e.g., a wireless network, through OQIs and report cards that facilitate to track operation and performance. Monitoring the pre-launch product can be performed through a set of monitoring time intervals {Δτ} 215; e.g., a day, a week, a month, or any time scale that is meaningful to the collection of performance data (e.g., data 129) through tests (e.g., test(s) 127).

As discussed above, performance tests are documented and collected data (e.g., data 129) can be aggregated and summarized for groups of one or more monitoring intervals 215. Based at least in part on aggregated data, summaries of monitored performance, scorecards for predetermined OQIs, client assessment platform can unilaterally decline Element acceptance 210 and declare a “No-Go” scenario, or grant Element acceptance 210 and declare a “Go” condition for a commercial launch.

After Element phase acceptance 210 is granted at time τ₀ 240₀, product performance and stability is to be monitored, or tracked, and documented as part of test(s) of R&S acceptance phase. Each of the N R&S periods 223_{λ} (λ=1, 2, 3 . . . N) assesses performance of product (e.g., deployed wireless network) in respective monitoring sets of time intervals {Δτ}_{λ} in which data (e.g., data 139) are collected via adequate test protocol(s), the data provides OQIs that are monitored and documented, e.g., reports are generated for one or more time intervals (e.g., a day, a week, a month . . . ) within a set {Δτ} 225_{λ}. Documented performance is conveyed from vendor platform(s) 105 to client assessment component 110. In an aspect, client assessment component 110 (e.g., a wireless service provider or carrier) can establish as many R&S periods as deemed necessary to aggregate sufficient data so as to satisfactorily characterize operational performance of product (e.g, wireless network). It should be appreciated that OQIs for R&S acceptance phase are specific thereto, and are generally defined by client assessment platform 110 independently of vendor platform(s) 105 or trough negotiation therewith. As an example of monitoring management within R&S phase acceptance, for each month in a R&S period 223_{λ}, vendor platform(s), or supplier, provides a monthly report that summarizes product (e.g., network) performance as determined by a set of OQIs, and overall health of the product. Such monthly report can include at least one of data from weekly reports, product (e.g., network) element reliability and stability statistics as determined through OQIs (e.g., average of underperforming events, standard deviation . . . ), or other pertinent information, such as feedback on perceived user experience from focus group of end users, that can be used to gauge product (e.g., network) performance.

It is noted that prior R&S periods 223_{λ}, product (e.g., wireless network) can be subject to monitoring over a predetermined time interval (e.g., a day) for a specific period of time (e.g., two weeks) before and after commercial launch, or element acceptance issuance. This monitoring period can serve as a product optimization or tune-up interval, wherein optimization or tune-up can be performed by client assessment platform 110 (e.g., wireless service provider or carrier) and vendor platform(s) or supplier as mutually agreed.

At the end of a set of R&S periods 223_{λ}, actual R&S acceptance phase 220 is entered. Tests within the context of this R&S acceptance phase can trigger additional “in-depth” tests before R&S acceptance is granted and conveyed to vendor platform(s) 105. As described above, tests within R&S acceptance phase 220 allow to invoke negotiated damages when R&Stability performance, as determined from collected OQI(s) data, fails to meet negotiated performance metrics for reliability and stability. When tests associated with R&S acceptance phase conclude and R&S performance metrics are attained or surpassed, R&S acceptance is issued at τ₁ 240₁. In an aspect, client assessment component 110, via at least in part analysis component 135, can utilize existing, aggregated monitoring and performance data to grant R&S acceptance. In another aspect, when new features, or operation alterations, have been implemented (e.g., deployed) into the product under R&S acceptance (e.g., deployed wireless network) during an R&S period, then testing of such features can be performed.

In an aspect of the subject innovation, subsequent to R&S phase acceptance issuance, an additional R&S period 223_{N+1} is conducted. Upon completion of such period, Final acceptance phase 230 is entered. Final acceptance phase 230 intends to verify that all products and corresponding interconnected product (e.g., wireless network) elements operate correctly, and provide full functionality and meet minimum performance requirements specified by client assessment component 110. It should be appreciated that Final acceptance phase 230 tests all product (e.g., network) elements and features that are deemed In-Service at the time Final acceptance phase occurs. It should further be appreciated that performance achieved at a time of Final acceptance phase are to be graded as either pass or fail with respect to whether the product (e.g., network) in this phase meets negotiated, or committed, operational quality indicator(s). A pass grade leads to Final acceptance issuance at τ₂ 240₂. As an example, when product is a wireless network, OQIs can include capacity metrics, quality metrics (e.g., speech quality) and telecommunication performance metrics.

It is noted that tests associated with Final acceptance phase 230 can trigger additional “in-depth” tests before Final acceptance is granted and conveyed to vendor platform(s) 105. Such tests within Final acceptance phase 230 allow to invoke negotiated damages when functionality and operational performance, as determined from collected OQI(s) data, warrants a fail grade. Based at least in part on failures or missing features committed to, fault severity will be determined agreed liquidated damages can be applied. It is further noted that, in an aspect, client assessment component 110 can utilize existing, aggregated monitoring and performance data to grant Final acceptance. In another aspect, when new features, or operation alterations, have been implemented (e.g., deployed) into the product under Final acceptance phase (e.g., deployed wireless network) during an R&S period (e.g., R&S period 223_{N+1}), then testing of such features can be performed. It is yet further noted that Final acceptance can be utilized to close out a purchasing contract (e.g., wireless network deployment contract) at which time, regular maintenance and operation of the product (e.g., wireless network) can begin under agreed provisions among client assessment component 110 and vendor platform(s).

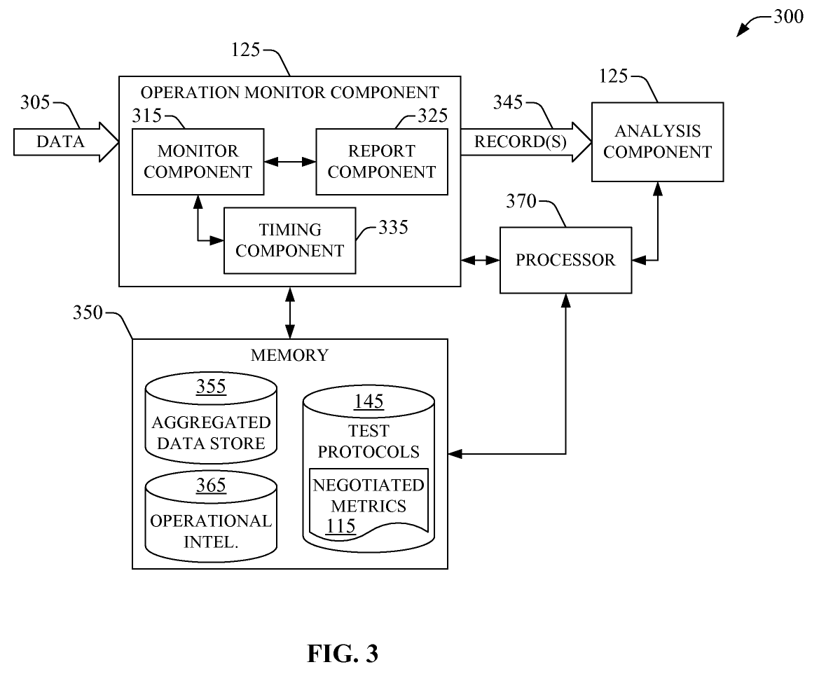

FIG. 3 illustrates a block diagram of an example embodiment 300 of an operation monitor component 125 that facilitates implementation of one or more tests related to operation and functionality of a product, and monitoring thereof, within a predetermined acceptance phase (e.g., R&S acceptance phase). In example system 300, operation monitor component gathers data 305 associated with functional and operational performance of a product in each acceptance phase in a set of acceptance phases. It should be appreciated that operation data can be distinct from functional data, with operational data related indicators that reveal whether a specific feature of product is operable, while functional data reveal whether an operable feature provides a desired performance once it is operated. Data 205, or performance data 205, is gathered through measurements performed by monitor component 315, which can probe, e.g., through performance tests, the product in accordance with monitoring time intervals {Δτ}; one or more time intervals can span a day, a week, a month, or substantially any time scale that allows probing operation and functionality of product. Timing component 335 can determine {Δτ} and can act as a clock to drive monitor component 315 to take measurements to determine the specific probed OQI. Measurements that are part of test(s) of a product in an acceptance phase are defined as part of test protocol(s) 145, which includes negotiated metrics 115. Test protocol(s) 145 includes definitions of various OQIs and necessary measurements to probe them at least in part. It should be appreciated that type of collected data 205 is determined by a specific probed OQI, which in turn is specific to the acceptance phase (e.g., acceptance phase II 143) in which the product is tested. Volume of collected data 205 depends at least in part on monitoring time intervals {Δτ}.

Collected data 305 and related OQI(s) can be documented via report component 325; report(s) or record(s) 345 typically summarizes product performance in one or more monitoring time intervals Δτ; e.g., daily reports, weekly reports, monthly reports, or the like. In an aspect, analysis component 125 received record(s) of performance of a tested product and facilitates determination of at least one of corrective measures or liquidated damages in accordance with negotiated terms. In another aspect, to determine corrective measures, at any phase of acceptance, analysis component 125 can utilize collected data 305 retained in aggregated data store 355. For instance, analysis component 125 can conduct root cause analysis to identify areas that originate failures in product performance, and thus recommend corrective measures. In addition, analysis component 125 can exploit aggregated data store to identify patterns of performance, and recommend areas of product improvement. Moreover, analysis component can utilize product specifications and associated standards for operation of a specific product to assess whether product meets standards. Information generated through analysis component 125 regarding operational and functional performance of a product in a specific phase of acceptance can be retained in operational intelligence 365, which is a memory element within memory 350.

Analysis component 125 can apply almost any mathematical algorithm for analysis of collected data 305. Among the example methodologies that analysis component 125 can employ for analysis are the following. (i) Computation of statistics of data distribution such as momenta (average, variance and standard deviation, . . . ). It should be appreciated that average computation can also include geometric averages and rolling averages. (ii) Calculation of time and space correlations, which can reveal effects of product deployment, e.g., frequency or other radio resource reuse when the product is wireless network; interaction among disparate portions of a product such as interference conditions among multiple wireless network deployments (e.g., macro coverage elements and service, femto cell coverage and service, and WiMAX coverage elements and service) within a specific service sector. (iii) Construction and implementation of risk models that evaluate product features and associated resource allocation to identify detrimental product deployments; e.g., when product is a wireless network, base station site(s) can be deployed in an area of documented heavy vandalism, which can increase service and maintenance resources. Implementation of risk models can be based on one or more of numerous methodologies for learning from data and then drawing inferences from the models so constructed. For example, Hidden Markov Models (HMMs) and related prototypical dependency models can be employed. General probabilistic graphical models, such as Dempster-Shafer networks and Bayesian networks like those created by structure search using a Bayesian model score or approximation can also be utilized. In addition, linear classifiers, such as support vector machines (SVMs), non-linear classifiers like methods referred to as “neural network” methodologies, fuzzy logic methodologies can also be employed. Moreover, game theoretic models (e.g., game trees, game matrices, pure and mixed strategies, utility algorithms, Nash equilibria, evolutionary game theory, etc.) and other approaches that perform data fusion, etc., can be exploited.

Processor 370 can be configured to confer, at least in part, functionality to operation monitor component 125, and components that reside thereon, and analysis component 125 as well. To that end, processor 370 can execute code instructions (not shown) stored in memory 350, and exploit related data structures (e.g., objects, classes). In addition, the foregoing algorithms (not shown) also can reside in memory 350, or in substantially any component within client assessment platform 110 that can be functionally connected to analysis component 125.

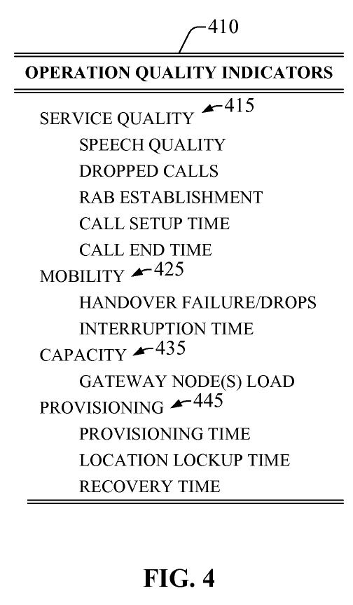

FIG. 4 presents a listing 410 of illustrative example categories of operation quality indicators (OQIs) that can be employed when a product is embodied in wireless telecommunication network. It should be appreciated that the illustrated OQIs can be employed in a phase of acceptance directed to monitoring network performance; e.g., R&S acceptance 220. Other categories of OQIs for a wireless network product are also possible based at least in part on specific phase acceptance. In addition, OQIs categories are available for other product(s); e.g., molecular beam epitaxy machines, industrial heat, ventilation and air conditioning system, or the like.

(i) Service Quality 415 category. This example category of OQI includes speech quality, dropped calls, radio access bearer (RAB) establishment, call setup time, and call end time. Speech quality (SQ) OQI can be based at least in part on backhaul quality for packet transport. It should be appreciated that SQ OQI can also be defined for end-to-end assessment of conversational quality. In an aspect, SQ OQI can be characterized via a mean opinion score (MOS) for call quality generated in an RTCP-XR TQ (Real-time Transport Protocol Control Protocol Extended Reports) Transmission Quality) report packet. In addition, or alternatively, for end-to-end assessment, PESQ (Perceptual Evaluation of Speech Quality) scoring for a mean opinion score (MOS) can be utilized to determine performance; thus, SQ OQI can be embodied on a MOS-PESQ scoring. Negotiated metrics 117 can include a threshold associated with SQ OQI established within the bounds of MOS for call quality. A test protocol associated with SQ OQI can include monitoring a specific number of TQ packets received in one or more access gateways (e.g., a femto cell access gateway) within a monitoring interval Δτ.

Dropped call(s) OQI can be divided in voice calls and data sessions. A test protocol for this OQI can monitor a set of K (with K a positive integer) calls in a Δτ monitoring interval (e.g., a 24 hour period). The OQI for dropped call(s) can be defined as the ratio among initiated calls that are dropped, and successfully established and completed calls. It should be appreciated that successfully established calls are those calls for which a radio access bearer (RAB) has been established and conveyed to a network management component within a wireless network platform (e.g., conglomerate of groups of product elements). Data dropped call(s) OQI can be determined in substantially the same manner as voice dropped call(s) OQI. Negotiated metrics 117 among vendor platform(s) 105 and client assessment platform 110 can comprise a threshold for voice or data dropped call(s) OQI.

In connection with RAB establishment, OQI can be determined for establishment success or failure, and for circuit switched or packet switched service as well. A test protocol associated with RAB OQI can comprise monitoring a predetermined set of attempts within an wireless network access gateway node (e.g., a Wi-Fi access gateway, or a femto cell access gateway), and determining the ratio of RAB successful attempts and RAB attempts, while the RAB OQI for failed RAB establishment can be computed as 1-(RAB OQI success ratio). Negotiated metrics 117 among vendor platform(s) 105 and client assessment platform 110 can comprise a threshold associated with RAB OQI and can be a specific percentage of RAB establishment success or failure per access gateway node.

With respect to call setup time, an OQI can be defined as the time interval Δt_{if} between a connection request (e.g., a Radio Resource Controller request through a random access channel (RACH) procedure) from a wireless network access point and a stop message (e.g., channel control (CC) alerting). Call setup can be associated with a mobile-to-telephony-network (e.g., public switched telephone network (PSTN)) or a mobile-to-mobile connection. (It should be appreciated product is embodied in a wireless network platform.) In an aspect, test protocol that can determine measurements effected by monitor component 315 can include monitoring a timer that starts with the first signaling instruction to setup a call and ends with reception of a stop message, for a set of calls placed through a set of subscriber stations served by a wireless network access point (e.g., a base station, a Wi-Fi access point, a femto cell access point . . . ). It is to be noted that such test protocol probes a product element, e.g., wireless network access point. Negotiated metrics 117 among vendor platform(s) 105 and client assessment platform 110 can comprise a threshold associated with the call setup time OQI can be an upper bound for Δt_{if} of the order of few seconds.

Call end time OQI can be determined in substantially the same manner as call setup time OQI. Suitable signaling events dictate termination request and termination resolution of a call. Test protocol and negotiated metrics are substantially the same as for call setup OQI.

(ii) Mobility 425 category. In this example category, handover OQIs can be defined to evaluate femto-to-macro successful and unsuccessful handover. OQIs can address inter-system (e.g., femto network to Universal Terrestrial Radio Access Network; both embodiments of conglomerate of groups of product elements) and intra-radio-access-technology (RAT) handovers for CS and PS calls or data sessions. It should be appreciated that various sources (e.g., physical channel failure, protocol error . . . ) can lead to unsuccessful handover. Accordingly, test protocol(s) for testing product performance as a part of phased acceptance can include evaluation of each source of handover failure through specific ad hoc measurements. In an aspect, a test protocol can include monitoring, over a time interval Δτ, a set of M (with M a positive integer) voice calls or data sessions served through a single wireless network access point (e.g., a femto AP); and computing a ratio of number of unsuccessful handover and handover attempts, or vice versa, based upon whether OQI is intended to address handover success or failure. Negotiated metrics 117 among vendor platform(s) 105 and client assessment platform 110 can comprise a threshold for handover OQI, which can be defined as a success rate with respect to the computed ratio described above.

Mobility 425 also can include interruption time as an OQI, the interruption time refers to a time gap in speech or data transmission as a result of handover. While for data sessions an interruption in data transfer is generally tolerable, interruption time in speech can result in poor perceived service quality by a subscriber. A test protocol associated with testing a product in connection with the subject OQI can include a time span Δt_{gap} of interrupted communication monitored over a set of wireless network access points (e.g., femto APs, or Wi-Fi APs). An interruption time OQI can be characterized as the either the average or largest Δt_{gap} for the probe ensemble. Negotiated metrics 117 among vendor platform(s) 105 and client assessment platform 110 can comprise a threshold for the interruption OQI, which can be asymmetric with respect to DL and UL and can be of the order of a few hundred milliseconds.

(iii) Capacity 435 category.—This capacity OQI example category can include load of gateway node(s) within a wireless network, which is a product embodiment, as an indicator of operational quality of the wireless network. The load refers to a processor load for processor(s) that confers at least part of the functionality to the gateway node(s), which can reside within a wireless network platform (e.g., a core network which is part of the wireless network or product). It should be appreciated that this OQI does not rely upon explicit telecommunication performance metrics (e.g., RSSP, RSOT, etc.) for the deployed base stations. As a part of test protocol(s) associated with the subject capacity OQI, gateway node(s) load can be measured for control and user planes; for each plane, mean processor load and peak processor load can be measured and identified as performance metrics. Test protocol(s) can include monitoring each of these performance metrics on a set of time interval Δτ (e.g., an hour, a day, a week . . . ). For control plane, processor(s) can be associated with a cell provisioning server, or an operation and maintenance server, both of which embody product elements. For the user plane, the processor can be associated with an application(s) server, which embodies a product element.

As an example, a capacity OQI can be the ratio of load over computing capacity of the processor platform available to gateway node(s). Negotiated metrics 117 among vendor platform(s) 105 and client assessment platform 110 can comprise a threshold associated with the capacity OQI. It should be noted that negotiated metrics 117 for capacity OQI can be different for control and user planes.

(iv) Provisioning 445 category.—The subject OQI example category can include at least the following: provisioning time, location lockup time, and recovery time. With respect to provisioning time, such OQI is directed towards a determination of a time span for assignment of a unique identifier to a wireless network access point (e.g, a femto AP, a Wi-Fi AP) added to the wireless network, or a wireless network access point that is reconfigured and requires a new identifier. The assignment can be accomplished by a suitable gateway node (e.g., an embodiment of product element). Such provisioning OQI is a functional OQI. In an example scenario, a test protocol includes the provisioning time that defines the OQI. In addition, test protocol includes monitoring provisioning time for a set of wireless network APs assigned a unique identifier within a predetermined time interval, which can be reset daily. Negotiated metrics 117 among vendor platform(s) 105 and client assessment platform 110 can comprise a time threshold Δtₜₕ^{(prov)} for provisioning time.

In connection with location lockup time, such OQI is directed towards a determination of a time span to acquire and communicate (e.g., lockup) a wireless network AP's location when first connected to the wireless network, or when reconfiguration requires a location to be reacquired for operation (e.g., the wireless network AP such as a femto cell AP is moved to a disparate location as a result of a subscriber moving from a first residence to a second residence). Test protocol(s) associated with testing wireless network as a part of phased acceptance can include a set of substantially all home-based wireless APs acquired by subscribers that reside in a specific area in a time interval Δτ, e.g., 24 hours. Negotiated metrics 117 among vendor platform(s) 105 and client assessment platform 110 can comprise a threshold for lock-up time Δtₜₕ^{(location)} and a fraction of wireless APs that incur a time longer than the threshold.

Recovery time includes re-establishment of telecommunication upon at least one of link loss or power loss. In an aspect, link loss can be determined through measurements over a set of time-frequency resources of signal-to-noise ratio(s) (SNRs), measured through RSOT, signal-to-interference ratio(s) (SINRs), measured through RSSI, or signal-to-noise-and-interference ratio, in conjunction with a signal strength tolerance that indicates when signal strength is inadequate for telecommunication. Thus, for example, test protocol(s) can include SNR measurement(s) over a resource block, as defined in the 3GPP Long Term Evolution wireless technology. As another example, test protocol(s) can include measurements of RSSI over a predefined number of frames N_{F}, e.g., N_{F}=100 which in 3GPP UMTS span 1 second. In addition, test protocol(s) can include monitoring a specific number Q (a positive integer, e.g., 5) of signal strength measurements, and a link-loss OQI threshold can be determined as Q consecutive measurements below signal strength tolerance, and represented through an accumulation function. Thus, link recovery takes place when less than Q consecutive radio link measurements below tolerance are realized. Negotiated metrics 117 among vendor platform(s) 105 and client assessment platform 110 can comprise a threshold for link recovery time Δtₜₕ^{(Lrec)} determined for a single wireless network AP or for a set of wireless network APs; for instance, Δtₜₕ^{(Lrec)} can be utilized as a threshold for Q consecutive measurements of a single wireless network AP, or for an average of Q measurements in various wireless network APs. It should be appreciated that other definitions of link loss can be utilized to determine an OQI associated with time recovery and link loss.

Likewise, an OQI for power loss can be introduced. As part of test protocol(s), measurements of transmitted power over a set of time-frequency resources can be conducted in a telecommunication and contrasted with a power tolerance that indicates power loss; for instance, RSRP can be probed over a resource block, or during a specific time interval for a set of channels either localized or interleaved. In addition, as part of test protocol(s), a specific number P (a positive integer) of measurements of received power through a pilot signal can monitored, and an OQI performance threshold can be determined as P consecutive measurements that yield data below signal strength tolerance; OQI can be represented through an accumulation function. Thus, power recovery takes place when less than P consecutive measurements of RSRP below tolerance are realized. It should be appreciated that power loss can be evaluated for substantially any wireless network component (e.g., within a radio access network or within a network platform or core network) through measurements of a time to acquire signal from one or more wireless access points after a power outage. As an example, negotiated metrics can include a time threshold Δtₜₕ^{(Ploss)} for a power-loss OQI, the threshold negotiated for a single wireless network AP or for an average synchronization time for a set of femto APs. It should be appreciated that other definitions of power loss can be introduced to determine an OQI associated with time recovery and link loss.

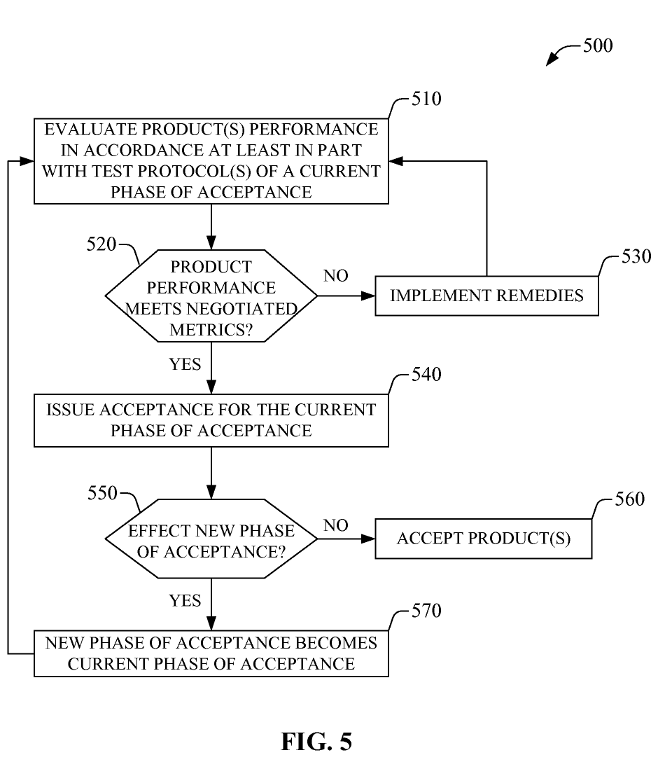

In view of the example systems described above, example methodologies, or methods, that can be implemented in accordance with the disclosed subject matter can be better appreciated with reference to flowcharts in FIGS. 5-9. For purposes of simplicity of explanation, example methodologies, or methods, disclosed herein are presented and described as a series of acts; however, it is to be understood and appreciated that the claimed subject matter is not limited by the order of acts, as some acts may occur in different orders and/or concurrently with other acts from that shown and described herein. For example, a methodology, or method, disclosed herein could alternatively be represented as a series of interrelated states or events, such as in a state diagram. Moreover, interaction diagram(s) may represent methodologies, or methods, in accordance with the disclosed subject matter when disparate entities enact disparate portions of the methodologies. Furthermore, not all illustrated acts may be required to implement a methodology, or method, in accordance with the subject specification. Further yet, two or more of the disclosed methodologies, or methods, can be implemented in combination with each other, to accomplish one or more features or advantages herein described. It should be further appreciated that the example methodologies, or methods, disclosed throughout the subject specification are capable of being stored on an article of manufacture to facilitate transporting and transferring such methodologies to computers for execution, and thus implementation, by a processor or for storage in a memory.

FIG. 5 presents a flowchart of an example method 500 for phased acceptance of one or more products in accordance with aspects described herein. The subject example method can be enacted by a client platform (e.g., client assessment platform 110) that assesses acquisition product. In an aspect, a processor that confers, at least in part, functionality of the client platform can enact one or more acts of the subject example method 500. A set of one or more phases of acceptance can be established based upon at least in part on one of strategic planning for product introduction, regulatory aspects (e.g., wireless and broadband emergency calls standards), marketplace behavior towards product(s) such as strong adoption, rejection to price point(s). In an aspect, subject example method 500 is enacted through a client platform, which can be embodied in a wireless service provider or carrier platform. The one or more products to be accepted can be provided through a vendor platform. It should be appreciated that the vendor platform can be internal to the carrier platform; e.g., a first division (e.g., Information Technology) develops a product (e.g., a billing application or component) for a second division (e.g., Femto Communications).

At act 510, product(s) is evaluated in accordance at least in part with test protocol(s) of a current phase of acceptance. At act 520 it is checked whether product(s) performance meets negotiated metrics. When the outcome of act 520 is negative, remedies are implemented at act 530. Remedies can include at least one of corrective measures in order to attain agreed performance metrics or collection of liquidated damages. Conversely, when the outcome of act 520 is affirmative, acceptance for the current phase of acceptance is issued at act 540. In an aspect, a component in a client platform facilitates to issue the acceptance, which can be recorded in a memory within the platform. At act 550 is it probed whether a new phase of acceptance is to be effected. A positive outcome leads to act 570, wherein the new phase of acceptance becomes the current phase of acceptance, with the ensuing adjustments to test protocol(s) and agreed metrics for the updated current phase of acceptance; flow is directed to act 510. A negative outcome from validation act 550 results in the product(s) being accepted at act 560.

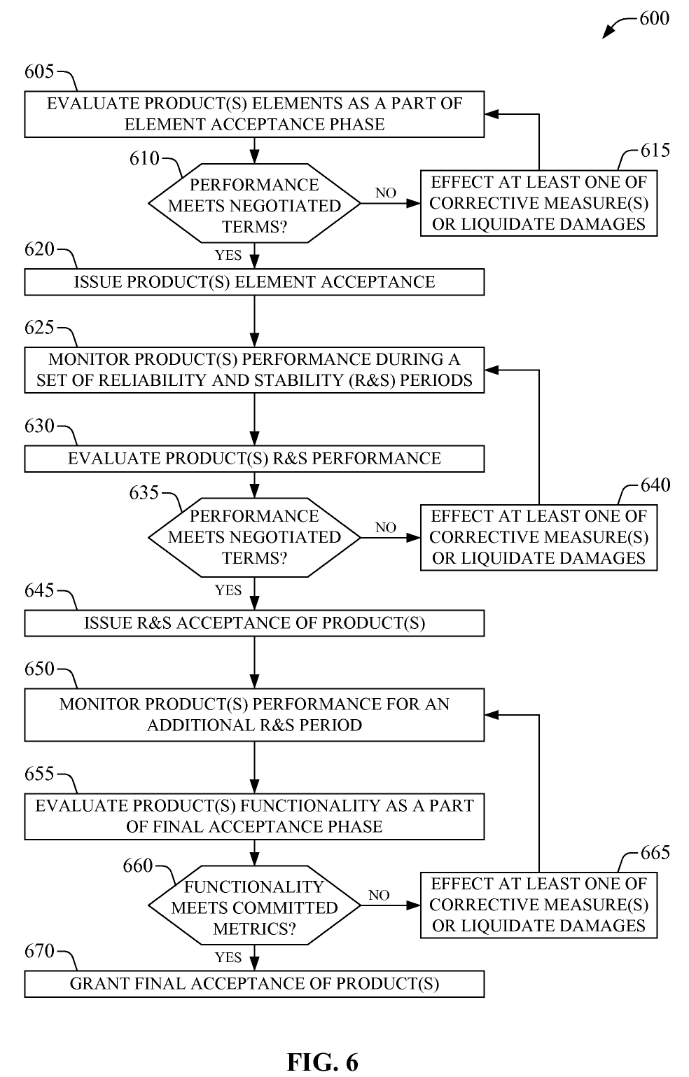

FIG. 6 presents a flowchart of an example method 600 for phased acceptance of product(s) in accordance with aspects described herein. A client platform (e.g., client assessment platform 110) can enact the subject example method 600. In an aspect, a processor that confers, at least in part, functionality of the client platform can enact one or more acts of the subject example method 600. In an aspect, phased acceptance in the subject example method 600 incorporates three distinctive phases of acceptance: Element acceptance, reliability and stability acceptance, and final acceptance. At act 605 product(s) elements are evaluated as part of element acceptance phase. At act 610 it is checked whether performance meets negotiated terms. Negotiated terms for performance can include attaining threshold performance in connection with a set of operation quality indicators. In the negative case, at least one of corrective measure(s) or liquidated damages are effected at act 615; flow is redirected to 605 to conduct evaluation after corrective measures. Liquidated damages can be negotiated at a time of negotiating OQI thresholds that determine acceptable performance. Conversely, when outcome of act 610 is affirmative, product(s) element acceptance is issued at act 620. In an aspect, a client platform issues acceptance.

At act 625, product(s) performance is monitored during a set of reliability and stability (R&S) periods. In an aspect, such R&S periods focus primarily on monitoring performance of product(s) at a commercial launch-level; e.g., a deployed test wireless communication network. The number of sets can be determined through feedback mechanism(s) that allows for monitoring added features to the product(s) during the R&S monitoring period. At act 630 the R&S performance of the product(s) is evaluated. In an aspect, evaluation can be based upon data collected (e.g., measured and documented) during the set of R&S periods. At act 635 it is checked whether performance meets negotiated terms. It should be appreciated that the negotiated terms are particular to the testing conducted during the R&S performance periods. In the negative case, at least one of corrective measure(s) or liquidated damages are effected at act 640; flow is redirected to 625 to conduct evaluation after corrective measures. Liquidated damages can be negotiated at a time of negotiating OQI thresholds that determine acceptable performance for R&S periods. Conversely, when outcome of act 610 is affirmative, R&S acceptance of product(s) is issued at act 645. At act 650, product(s) performance is monitored for an additional R&S period. At act 655, product(s) functionality is evaluated as part of a final acceptance phase. Functionality includes functionality of all services that the product(s) are intended to provide, as well as functionality of product(s) elements (e.g., a femto cell access point) that are provided to end user(s) (e.g., a femto cell subscriber). At act 660 it is checked whether functionality meets negotiated terms. It should be appreciated that the negotiated terms are particular to the functionality intended for, or desired from, commercially available and marketable product(s). In the negative case, at least one of corrective measure(s) or liquidated damages are effected at act 665; flow is redirected to 650 to conduct evaluation after corrective measures. Liquidated damages can be negotiated at a time of negotiating intended or expected functionality of product(s). Conversely, when outcome of act 660 is affirmative, final acceptance of product(s) is granted at act 670.

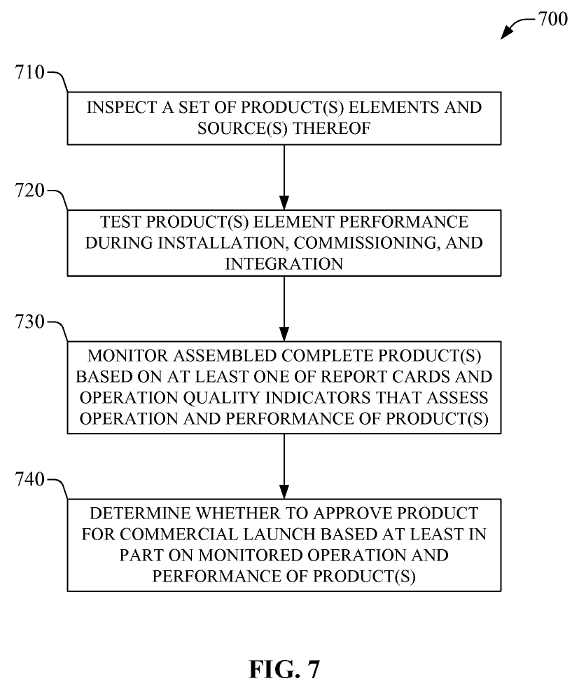

FIG. 7 is a flowchart of a method 700 for evaluating product(s) elements as a part of an element phase acceptance according to aspects described herein. A client platform (e.g., client assessment platform 110) can enact the subject example method 700. In an aspect, a processor that confers, at least in part, functionality of the client platform can enact one or more acts of the subject example method 700. It is to be noted the subject example method 700 can be employed in conjunction with one or more of the example methods described in the subject specification. At act 710, a set of product(s) elements and sources thereof (e.g., manufacturing plant(s)) are inspected. As a part of an inspection, predetermined testing can be conducted on selected batches of product(s) elements (e.g., transceiver performance, multiplexer performance, noise level of optical fiber link of a specific length . . . ) At act 720, product(s) element performance is tested during installation, commissioning, and integration. At act 730, assembled (e.g., deployed) complete product(s) are monitored based upon report cards and OQIs that assess operation and performance of product(s). It should be appreciated that various categories of OQIs can be established (e.g., see FIG. 4) based at least in part on acceptance phase being implemented, or specifics of the assembled product(s). At act 740, it is determined whether to approve product(s) for commercial launch based at least in part on monitored operation and performance of product(s).

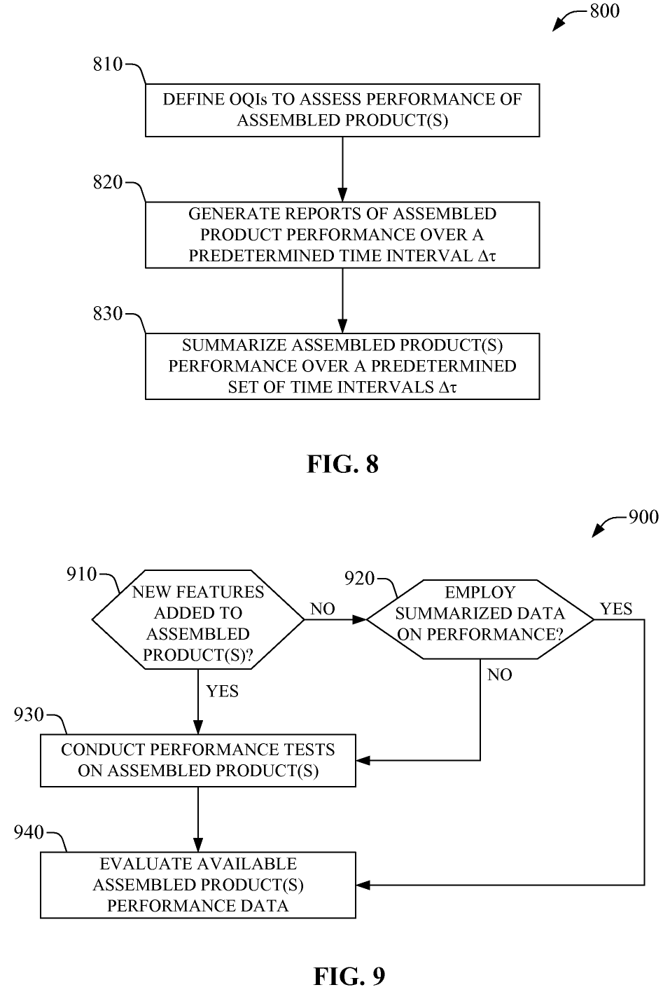

FIG. 8 is a flowchart of an example method 800 for monitoring performance during an R&S period(s) according to aspect of the subject innovation. A client platform (e.g., client assessment platform 110) can enact the subject example method 800. In an aspect, a processor that confers, at least in part, functionality of the client platform can enact one or more acts of the subject example method 800. It is to be noted the subject example method 800 can be employed in conjunction with one or more of the example methods described in the subject specification. At act 810, OQIs are defined to assess performance of assembled product(s). It should be appreciated that various categories of OQIs can be established (e.g., see FIG. 4) based at least in part on acceptance phase being implemented, or specifics of the assembled product(s). At act 820, reports of performance over a predetermined monitoring time interval Δτ are generated. The reports can be retained to facilitate performance analysis. At act 830, performance of assembled product(s) over a predetermined set of time intervals Δτ is summarized. Such summaries can include input from retained documented product performance associated with generated reports.

FIG. 9 is a flowchart of an example method 900 for evaluating performance of product(s) according to aspects of the subject innovation. A client platform (e.g., client assessment platform 110) can enact the subject example method 900. In an aspect, a processor that confers, at least in part, functionality of the client platform can enact one or more acts of the subject example method 900. The subject example method 900 can be employed with one or more of the example methods described herein. At act 910, it is probed whether new features are added to assembled product(s). In the affirmative case, performance tests of the product(s) are conducted at act 930. In the negative case, at act 920, it is probed whether to employ summarized data on product(s) performance. When the outcome of act 920 is negative, product(s) performance tests are conducted at act 930. Conversely, assembled product(s) performance is evaluated based on available performance data in act 940.

Various aspects or features described herein may be implemented as a method, apparatus, or article of manufacture using standard programming and/or engineering techniques. In addition, it is to be noted that the various aspects disclosed in the subject specification can be implemented through program modules stored in a memory and executed by a processor, or other combination of hardware and software, or hardware and firmware. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

What has been described above includes examples of systems and methods that provide advantages of the subject innovation. It is, of course, not possible to describe every conceivable combination of components or methodologies for purposes of describing the subject innovation, but one of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method for accepting a purchased product, the method comprising:
employing at least one processor to execute acts for accepting the purchase product, the acts including:
evaluating product elements as a part of an element acceptance phase;
issuing product element phase acceptance when evaluated performance meets negotiated terms;
monitoring product performance during a set of reliability and stability (R&S) periods;
evaluating product R&S performance and issuing R&S phase acceptance of the product when performance meets negotiated terms; and
evaluating product functionality as a part of final phase acceptance and granting final acceptance of the product when functionality meets committed metrics.

2. The method of claim 1, when at least one of product performance or product functionality fails to meet committed metrics, effecting at least one of corrective measures or liquidated damages.

3. The method of claim 2, wherein liquidated damages are negotiated among a client and a vendor and are determined based at least in part on fault severity associated with failures that resulted in implementation of corrective measures.

4. The method of claim 1, wherein evaluating product elements as a part of an element acceptance includes inspecting a set of product elements and one or more sources thereof.

5. The method of claim 4, wherein evaluating product elements as a part of an element acceptance further includes testing product elements performance during installation, commissioning and integration.

6. The method of claim 5, wherein evaluating product elements as a part of an element acceptance further includes:
monitoring an assembled complete product based at least on operation quality indicators that assess operation and performance of the product; and
determining whether to approve product for commercial launch based at least in part on monitored operation and performance of the product.

7. The method of claim 1, wherein monitoring product performance during a set of reliability and stability (R&S) periods includes defining operation quality indicators to assess performance of an assembled product.

8. The method of claim 7, wherein monitoring product performance during a set of R&S periods includes:
generating reports of an assembled product performance over a predetermined time interval; and
summarizing the assembled product performance over a predetermined set of time intervals.

9. The method of claim 1, wherein at least one of evaluating product R&S performance or evaluating product functionality includes conducting performance tests on an assembled product when one or more new features are added to the assembled product.

10. The method of claim 9, further comprising employing summarized data on performance when features of the assembled product remain same.

11. The method of claim 10, further comprising evaluating available data on assembled product performance data when summarized data on performance is employed.

12. A system that facilitates to accept a product purchase, the system comprising:
a computer-implemented negotiation component that determines negotiated performance metrics associated with a set of acceptance phases; and
a computer-implemented operation monitor component that implements each phase of acceptance, implementation includes collection of data associated with functional and an operational performance of the product in each set of acceptance phases; and
a computer-implemented analysis component that facilitates determination of at least one of corrective measures or liquidated damages in accordance with agreed terms based at least in part on the operational performance of the product.

13. The system of claim 12, wherein a product associated with the product purchase is multi-component entity that requires one or more stages of integration, commission and deployment, or field tests prior to being fully functional.

14. The system of claim 12, wherein the set of acceptance phases comprises three phases of acceptance including an element acceptance phase, a reliability and stability acceptance phase, and a final acceptance phase, the final phase of acceptance closes out product purchase.

15. The system of claim 12, wherein liquidated damages are determined based at least in part on fault severity associated with a product performance failure that resulted in implementation of corrective measures.

16. The system of claim 12, wherein the computer-implemented analysis component grants acceptance of a phase acceptance based at least in part on collected data performance that meets agreed metrics.

17. The system of claim 12, wherein the computer-implemented analysis component includes:
a computer-implemented monitor component that measures product performance in accordance with one or more test protocols, the test protocols include a set of measurements necessary to evaluate an operation quality indicator; and
a computer-implemented report component that documents product performance in one or more monitoring time intervals as a part of a phase of acceptance.

18. A computer-readable storage medium having stored code instructions thereon that, when executed by a processor, cause a processor to carry out the following acts:
evaluating the product performance in accordance at least in part with a test protocol of a current phase of acceptance;
issuing acceptance for the current phase of acceptance when product performance meets negotiated metrics;
when a new phase of acceptance is to be effected, evaluating the product performance in accordance at least in part with a test protocol of a new phase of acceptance; and
accepting the product when the current phase of acceptance is final acceptance.

19. The computer-readable storage medium of claim 18 having further code instructions that, when executed by a processor, cause a processor to carry out the act of implementing remedies when the product performance of a current phase of acceptance fails to meet negotiated performance.

20. The computer-readable storage medium of claim 19, wherein the remedies include at least one of corrective measures or liquidated damages.
